(19) United States
(12) Patent Application Publication
(10) Pub. No.: US 2013/0246226 A1
(43) Pub. Date: Sep. 19, 2013

(54) SYSTEM AND METHOD FOR ENABLING CONSUMER PROMOTION, SALE, OR GIFTING OF CONTENT ITEMS SUCH AS MOVIES

(71) Applicants: SONY CORPORATION, Tokyo (JP); SONY PICTURES TECHNOLOGIES, INC., Culver City, CA (US)

(72) Inventor: Richard Berger, Westlake Village, CA (US)

(73) Assignees: Sony Pictures Technologies, Inc., Culver City, CA (US); Sony Corporation, Tokyo (JP)

(21) Appl. No.: 13/890,708

(22) Filed: May 9, 2013

Related U.S. Application Data
(62) Division of application No. 13/336,472, filed on Dec. 23, 2011.
(60) Provisional application No. 61/428,492, filed on Dec. 30, 2010.

(51) Int. Cl. G06Q 30/06

(52) U.S. Cl. CPC G06Q 30/0641
USPC 705/27.1

(57) ABSTRACT

Apparatus and methods to implement a technique for selling content such as movies online. In one implementation, a user obtains permission from the content owner to sell access to an item of video content. The user acts as a promoter for the content and receives compensation from the content owner for each sale. The user does not have or create copies to transfer to buyers—the commercial transaction and fulfillment are provided by the content owner. The user can build a library or online store of content that the user promotes. In another implementation, the system provides significant gifting functionality for content items, such as for providing previews and gift wrapping skins for gifted content items.

### CROSS-REFERENCE TO RELATED APPLICATIONS

This application is a divisional of U.S. application Ser. No. 13/336,472, filed Dec. 23, 2011 entitled SYSTEM AND METHOD FOR ENABLING CONSUMER PROMOTION, SALE, OR GIFTING OF CONTENT ITEMS SUCH AS MOVIES, which claims benefit of priority of U.S. Provisional Patent Application Ser. No. 61/428,492, filed Dec. 30, 2010, entitled “MOVIE SELLER”, owned by the assignee of the present invention and incorporated herein by reference in its entirety.

### BACKGROUND

Delivery of online content such as movies, television shows, and music has transformed the way consumers receive such content items. In the same way, social networking has transformed the way people interact. For example, a movie which interests one user of the social networking site and for which an entry is posted on the site may lead to a long thread where the user and his or her friends interact with each other by commenting on the movie.

But current sales of online content are basically Internet versions of “brick and mortar” stores. For example, the type of power wielded by an influential user on a social networking site cannot be leveraged in any such existing online marketplace. Nor is there any interesting way to enhance a gifting experience, either for the purchaser or the recipient, these being currently limited to providing a coupon or gift certificate.

### SUMMARY

A content owner, such as a movie studio, can increase its sales of movies by letting consumers promote sales of movies. In one implementation of a “movie seller” system, a movie selling service provides an interface between users-as-sellers and content owners. The content owners register available movies with the selling service. Users can register with the service as sellers and receive access to the registered content. The sellers can use websites/pages provided by the seller service or operate their own. Content owners can also provide materials to help promote the content items, e.g., stills, audio, trailers, other clips, or the like.

In one implementation, the selling service may provide tools, e.g., links, that the seller can present to buyers which when activated will start the purchase process. The purchase request comes back to the selling service which routes or hands off the purchase requests to the content owners. Alternatively, the request may be sent directly to the content owner. The content owner completes the sales transaction and provides the content to the buyer.

In another implementation, the purchaser only rents the content item, i.e., receives a limited time license, or buys access to streaming. The service provider or content owner tracks sales by the seller and provides benefits or credits to the seller, which can be compensation but which may also be of a type to help promote further sales, e.g., free clips, promotional items, or discounts.

In a further implementation, the service is provided by the content owner directly. In one simple example, the movie selling service provides clips with embedded purchasing links. A user can register and download the clip or a link to the clip and may further share the clip on a website or through other forms of communication, e.g., e-mail. An embedded purchasing link may then be activated by the purchaser or another user to contact either the selling service or the content owner to purchase the movie or other related content.

In a more sophisticated example, a seller establishes their own website promoting multiple titles including commentary or other content intended to drive sales. Again, once a purchase begins, the request is passed back to the service or content owner to complete the transaction.

In another implementation, pricing is controlled by the content owner and defined when the content is provided to or registered with the selling service. In a further implementation, pricing can be managed by the seller. For example, the content owner or service may set a fixed cost or set a floor price, but the seller can raise the price above that cost and keep the margin. In another example, the seller can set the price however they wish, but may owe the content owner for any sales below a defined cost. These approaches allow the seller more flexibility in marketing, such as by promoting bundles, loyalty benefits, loss leaders, or special promotions. In one example, a seller could bundle the movie with some other good provided by the seller, e.g., clothing. In another example, a seller establishes a subscription fee for purchasers and pays the content owner directly for each specific purchase under a purchaser's subscription. The content owner may also establish a subscription model. In any case, the resolution of payment may be handled at the time of the transfer to the buyer. In some implementations, the specifics of how the seller is charging consumers is transparent to the content owner so long as the content owner receives the set cost.

In another implementation, the seller can also provide gifts, instead of direct sales. The purchaser then pays for the content and to have the content delivered or otherwise provided to a recipient. The commercial transaction and fulfillment are otherwise similar to a direct sale. In a further implementation, the gift mechanism is not for a complete gift, but rather for a discount. For example, when the purchaser purchases a movie from a seller, the seller can provide the purchaser with a discount that can be applied to a future sale or transferred to another user as a gift. The discount can be for the same movie or for another item. The cost of the discount can be paid by the purchaser, the seller, the movie selling service, the content owner, or a combination. In yet a further implementation, a purchaser can buy the gifts directly from the content owner, possibly receiving a discount in return from the same.

In another implementation, the seller operates with a social networking site. The seller presents items for sale on the seller's page on the site. The site may further provide or sell information to a seller to help promote sales, such as the preferences of users who may find the promoted content items of interest. In a further implementation, the site can provide advertising space to the seller on potential purchaser pages.

In another implementation, the selling service is set up as its own social networking site. Users can discuss and promote movies with each other and receive benefits for completed transactions, e.g., rentals, sales, and streaming. Accordingly, the technology is not limited to the specific examples of implementations discussed.

In another implementation, interest and sales in content items such as movies may be increased by provision of a gifting system and method. A gifting system and method may provide not only a way for users to purchase digital content items for other users, but may also greatly increase interest in the received gifts by providing functions such as a preview before acceptance, a gift wrap skin that may be removed in an interesting manner, and the like. Such gifts may be made not only through an online content service but also through multiple online content services by making such purchases within the framework of a rights administrator service or digital rights locker.

In one aspect, the invention is directed towards a method of operating an online marketplace for digital content items, including: providing a selling service, the selling service associated with a content item rights owner; and configuring the selling service to allow registrations of one or more sellers with respect to one or more content items, rights to the content items owned by respective content item rights owners, a registered seller permitted and configured to promote, offer for sale, and initiate a transaction for a content item between the content item rights owner and a purchaser of the content item.

Implementations of the invention may include one or more of the following. The selling service may be further configured to, upon initiation of a transaction, handoff the transaction to be completed by the purchaser and the content item rights owner. The handoff may be to the content item rights owner or to a fulfillment vendor. The content item rights owner may be an online content service or may be associated with a rights administrator service. The method may further include receiving a right pertaining to the transacted content item and transmitting the right to the purchaser. The right may be embodied at least partially in a redemption code. The method may further include receiving audiovisual content items from the content item rights owner. The method may further include transmitting one or more of the audiovisual content items from the selling service to at least one seller. The method may further include receiving a website template from the content item rights owner and transmitting the website template from the selling service to at least one seller. The method may further include, upon the occurrence of a transaction, providing a credit from the content item rights owner to an account associated with the seller.

In a further aspect, the invention is directed towards a non-transitory computer readable medium, including instructions for causing a computing device to perform the above method.

In another aspect, the invention is directed towards, in a system where a seller has received a right to promote and initiate a sale of a content item from a content item rights owner through a selling service, a method of marketing the content item through a social networking site, including: receiving audiovisual content items from a content item rights owner pertaining to a content item; populating a feed compliant with an API of a social networking site using at least a portion of the audiovisual content items received; transmitting the feed to a social networking site or to an application operable on the social networking site; and receiving a purchase request from a user on the social networking site for the content item.

Implementations of the invention may include one or more of the following. The audiovisual content items may include at least one of: a link, a clip, a still, a game, a quiz, or combinations thereof. The method may further include receiving data about potential purchasers, the potential purchasers members of the social networking site, and further includes advertising the content item on pages of the social networking site associated with the potential purchasers. The purchase request may be a request for a download, a rental, a streaming video, or for an inclusion in a digital rights locker, of the content item.

In a further aspect, the invention is directed towards a non-transitory computer readable medium, including instructions for causing a computing device to perform the above method.

In yet a further aspect, the invention is directed towards a method of providing a gifting functionality for an online marketplace for digital content items, including: providing a browsing and discovering functionality for a plurality of content items; providing a selection functionality, where a user may select a content item from one or more of the plurality for gifting; providing a personalization functionality for the selected content item, where the content item may be combined with one or more personalization content items into a packaged content item; providing a transaction functionality for the packaged content item, where a gifter provides compensation at least for the selected content item to a content item rights owner; providing a transmission functionality for the packaged content item, where the packaged content item is caused to be transmitted and delivered to a recipient; and providing a preview functionality for the packaged content item, where the packaged content item may be previewed prior to acceptance by the recipient.

Implementations of the invention may include one or more of the following. The personalization content item may include a gift wrapping skin for the selected content item, and may further include providing an unwrapping functionality for the packaged content item, where a user interface of a recipient device is configured to provide the appearance of unwrapping the gift wrapping skin of the packaged content item. The appearance of unwrapping the gift wrapping skin may include removing the appearance of the gift wrapping skin from locations activated by a user on a touchscreen. The method may further include associating the selected content item with a recipient account. The associating may include downloading the content item to a device affiliated with the recipient account, streaming the content item to a device affiliated with the recipient account, providing a rental right of the content item to the recipient account, or associating the content item with the recipient account in a digital rights locker. The method may further include receiving a request to share information about the selected content item from the recipient account, preparing the information in a way compliant with an API of the social networking site, and transmitting the information to the social networking site. The method may further include receiving a request to return the selected content item from the recipient account, or a request to exchange the selected content item, and providing a functionality to perform the return or exchange. The associating may include receiving an entry of a redemption code. The method may further include providing a gifting reminder functionality, the gifting reminder functionality serving to remind users, associated with a potential recipient, of an event associated with the potential recipient.

In a further aspect, the invention is directed towards a non-transitory computer readable medium, including instructions for causing a computing device to perform the above method.

In yet another aspect, the invention is directed towards a system for providing a gifting functionality for an online marketplace for digital content items, including: a web service API module, the web service API module configured to interact with a source of rights to digital content items; and a gifting experience user interface module, the gifting experience user interface module configured to interact with a user device to receive gift purchase requests from purchasers and provide gifted digital content items to recipients.

Implementations of the invention may include one or more of the following. The web service API module may include a grant coupon API module for providing and implementing business rules for a content item and a redemption code API module for receiving a redemption code from a recipient and converting the redemption code into a right to a content item to be delivered to the recipient. The system may further include a feed service module for populating a feed about a transacted content item usable by a social networking site to publish information about the transaction to the social networking site.

Advantages may include one or more of the following. A license may be provided to a user from a content item rights allowing the user to become a seller of content items or to refer buyers to content item sellers. In this way, overall sales may be increased by allowing users to develop new and interesting ways of selling content items. In addition, the interest a seller has for content items increases by becoming identified with the content item as well as by being compensated for its sale. In some implementations, sales and interest in content items may be caused to increase by providing additional gifting functionality for content items, allowing such to be gifted to recipients where the presentation of such gifts is highly interesting and rewarding. Such implementations provide a compelling digital gift experience to stimulate buying. The gift experience may be a component of an integrated program to create awareness of and drive traffic to other applications and products in the program. Gifting may be employed as a test vehicle for commercial offers, as well as for new pricing models and business models. The gifting experience may create an ongoing conversation with customers to better understand their desires and create more highly targeted offers to trigger the buying decision.

### BRIEF DESCRIPTION OF THE DRAWINGS

FIG. 1 is a schematic diagram of a first implementation of a system according to the principles described here;

FIG. 2(A) is a flowchart illustrating a first implementation of a method according to the principles described here;

FIG. 2(B) is a flowchart illustrating a second implementation of a method according to the principles described here;

FIG. 3 is a flowchart illustrating a third implementation of a method according to the principles described here;

FIG. 4 is a flowchart illustrating a fourth implementation of a method according to the principles described here;

FIG. 5(A) is a flowchart illustrating a fifth implementation of a method according to the principles described here;

FIG. 5(B) is a flowchart illustrating a sixth implementation of a method according to the principles described here;

FIG. 6(A) is a flowchart illustrating a seventh implementation of a method according to the principles described here;

FIG. 6(B) is a flowchart illustrating an eighth implementation of a method according to the principles described here;

FIG. 7 is a flowchart illustrating a ninth implementation of a method according to the principles described here;

FIG. 8 is a schematic diagram of a second implementation of a system according to the principles described here;

FIG. 9 is a flowchart illustrating a tenth implementation of a method according to the principles described here;

FIG. 10 is a diagram illustrating ways and sources in which a gift purchase may be initiated;

FIG. 11 is a schematic diagram of a third implementation of a system according to the principles described here;

FIG. 12 is a sequence diagram of an implementation according to the principles described here; and

FIG. 13 illustrates an exemplary structure of a computing device that may be employed to implement one or more of the features described herein.

Like reference numerals indicate like elements in the drawings. Elements are not drawn to scale unless otherwise indicated.

### DETAILED DESCRIPTION

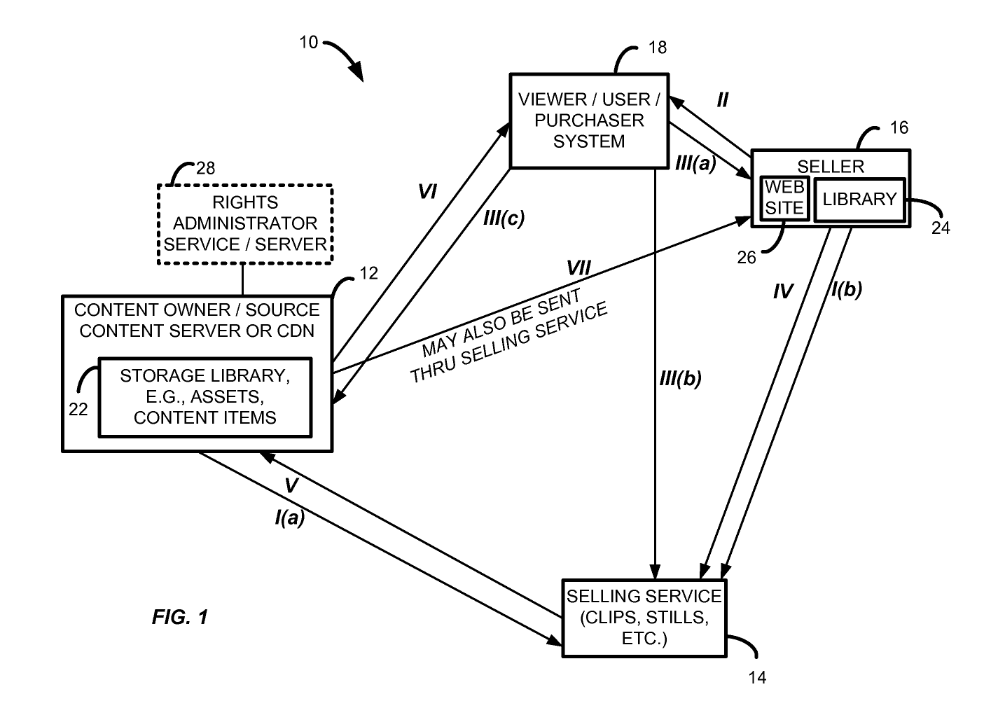

FIG. 1 illustrates a system 10 that may implement the principles described here. In the figure, the system 10 includes a content owner or source 12. The content owner or source typically provides content items by way of a content server or content delivery network. While the term “content item” provides a shorthand for what is essentially an electronic file or data construct, the term is generally associated with a right that is sold to a purchaser to access a content item in some way, as opposed to all of the rights associated with the content item. The content owner 12 may be an online content service which itself houses content items, or maybe an intermediary.

The system 10 further includes a selling service 14. The selling service may be implemented in a number of ways, including by being hosted on an Internet server, by being implemented on a user system, or in other ways so long as the selling service is configured to access the content owner 12, the seller, and purchasers, users, or viewers. The selling service 14 may be developed by a content owner, may be a third-party product, or may be developed and operated by a rights administrator service, also termed herein a “digital rights locker”, as will be described. The selling service 14 may house, or have access to, various clips, stills, or other audiovisual content items associated with the content items being sold. Such audiovisual content items are generally provided from the content owner 12, and in particular from a storage library 22 of such audiovisual content items, the storage library 22 further housing the content items themselves. It will be understood that the actual storage location of such items is immaterial, so long as the content owner and selling service can access the same when necessary. It will also be understood that the selling service may form a portion of a content owner 12, e.g., as a separate software module at a front end of the same.

A seller 16 is illustrated, and the seller may operate perform its functionality in any way so long as the seller can access the selling service, purchaser systems, and optionally a content owner. The seller 16 may be provided with various features to help promote and sell content items, and may even include a website template 26 provided by the content owner or the selling service. Alternatively, the seller 16 may develop their own website to sell their content, such content being listed in a seller library 24.

Various purchaser systems 18 are illustrated, such systems 18 associated with viewers, users, and/or purchasers. In systems and methods according to the principles described here, such viewers are enticed to purchase by marketing and/or promotions on the website 26 of the seller 16.

While the system above is described with respect to a content owner 12, it will be understood that the system and methods according to the principles described here are fully implementable with respect to a plurality of such content owners, the libraries of such controlled by a rights administrator service 28 such as the UltraViolet™ system developed by the DECE Consortium. In such an implementation, it will be understood that the selling service may form a portion of the rights administrator service 28, e.g., as a separate software module at a front end of the same.

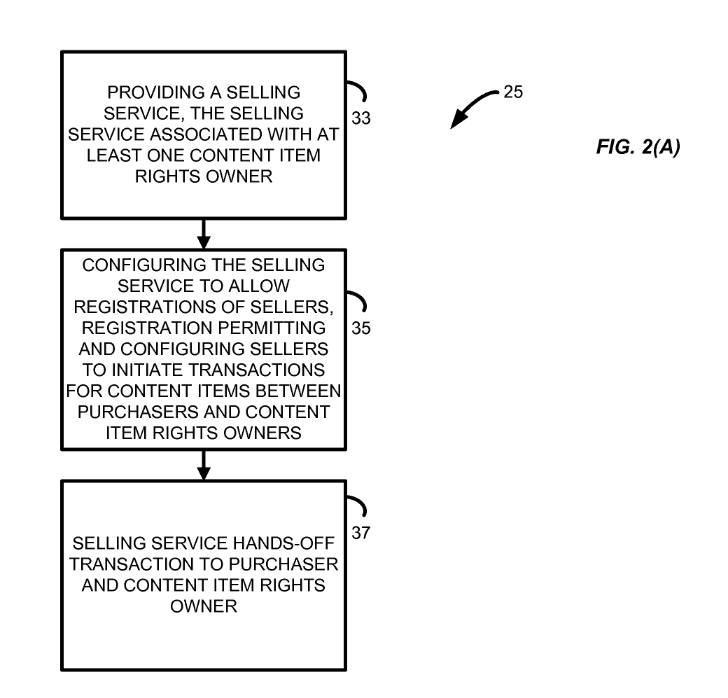

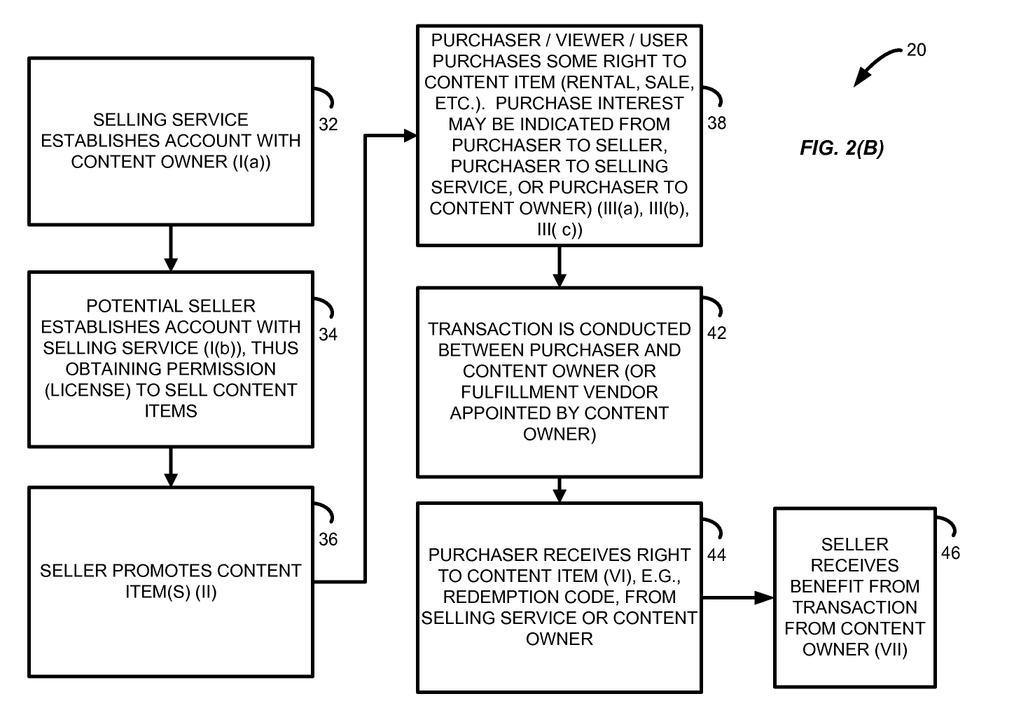

Details of the methods of FIG. 1, including steps enumerated by roman numerals I(a)-VII, will be described below in connection with FIG. 2(B).

Referring to FIG. 2(A), a flowchart 25 is depicted illustrating a first implementation of a method according to the principles described here. A first step of the method 25 is to provide the selling service, the selling service associated with at least one content item rights owner (step 33). The selling service may be provided by the content item rights owner, such as an online content service, a rights administrator service, or the like.

A next step is that the selling service is configured to allow registrations of sellers, registration permitting and in some fashion configuring sellers to initiate transactions for content items between purchasers and rights owners (step 35). For example, registration with respect to a given content item allows the seller to market the item on the Internet, initiate transactions to the extent of a handoff of the actual purchase transaction to the content owner or a fulfillment vendor, or the like. Consequently, the configuring may simply be the provision of the license to sell, but may also include more complicated configurations such as the provision of coupon codes, redemption codes, audiovisual content items such as clips, trailers, stills, or the like.

A next step is that the selling service hands off the transactions to be conducted between the purchaser and content item rights owner (step 37). In this way, the content item rights owner deals directly with the purchaser to complete the transaction.

It will be understood that variations of the above may also occur. For example, the transaction may be conducted through the selling service, or in some cases the selling service may play a larger role in the transaction, particularly if the selling service is a front end for an online content service. In another alternative implementation, instead of handing off the transaction to the content item rights owner, the selling service may also hand the transaction off to a fulfillment vendor appointed by the content item rights owner. Other variations will also be understood given this teaching.

Referring to FIG. 2(B), a flowchart 20 is illustrated depicting a second implementation of a method according to the principles described here. The flowchart 20 also refers to steps enumerated by roman numerals in FIG. 1. A first step is that a selling service establishes an account with a content owner (step 32), this step indicated in FIG. 1 by I(a). A next step is that a potential seller establishes an account with the selling service, thus obtaining permission or a license to sell content items (step 34), this step indicated in FIG. 1 by I(b). It will be understood that where the selling service serves as a front end for an online content service or rights administrator service, the account may be with the content item rights owner or the rights administrator service, respectively.

The seller may then promote one or more content items associated with their library (step 36), this step indicated in FIG. 1 by II. The seller may have been provided various audiovisual content items to help the cause of such promotions from the selling service or the content item rights owner directly, such audiovisual content items including clips, stills, trailers, games or the like. The seller may further have been provided website templates or online storefronts to further promote the content items. The provision of such website templates or online stores may in some cases help to strengthen the brand identification of the content items within the seller library by providing a uniform theme.

A next step is that a purchaser purchases some right to the content item (step 38), this step indicated in FIG. 1 by III(a), III(b), or III(c). The right may be for a download, rental, streaming, including streaming available for a limited period of time, or the like. Interest in a purchase is generally indicated from the purchaser to the seller (III(a)), followed by the seller communicating with the selling service (IV) and subsequently the content owner (V) to complete the transaction. However, in other configurations, the purchaser may be directed to the selling service (II(b)) or to the content owner (III(c)) directly upon indication of interest.

A next step is that a transaction is conducted between the purchaser and the content owner, or a fulfillment vendor appointed by the content owner (step 42). The transaction may be conducted in a number of known in the field of e-commerce of digital content items.

The transaction then results in the purchaser receiving a right to the content item (step 44), this step indicated in FIG. 1 by VI. For example, the purchaser may receive a redemption code from the content owner allowing the purchaser to, upon redemption, download a copy of the content item or receive streaming rights.

A final step within FIG. 2(B) is that the seller receives a benefit or credit from the transaction from the content owner (step 46), this step indicated in FIG. 1 by VII. The benefit or credit may be to a seller account or to another account associated with the seller. It will be understood that the benefit or credit, while generally paid by the content owner, may be sent through the selling service, a rights administrator service, or the like.

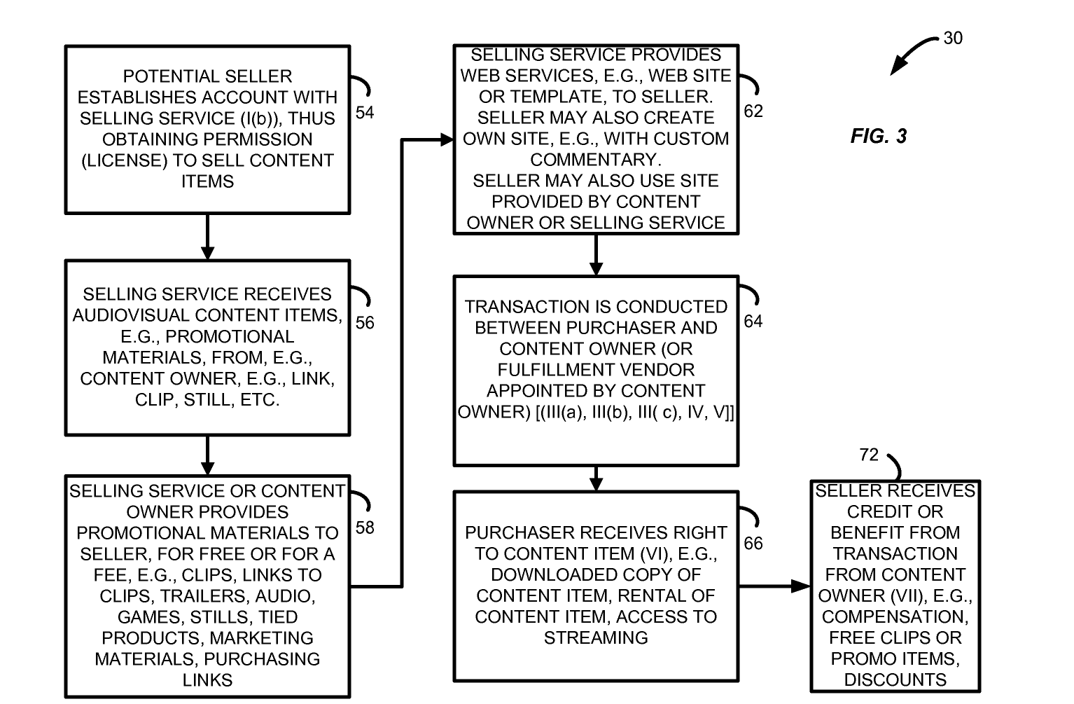

FIG. 3 shows a flowchart 30 illustrating a third implementation of a method according to the principles described here. The flowchart 30 generally shows how sellers work with content owners and the selling service. A first step is that a potential seller establishes an account with the selling service, thus obtaining permission to sell content items from the rights owner (step 54). This step is similar to the first step of FIG. 2(B). A next step is that the selling service receives audiovisual content items, e.g., promotional materials, from the content owner (step 56). Such promotional materials may include clips, links to clips, stills, games, or any such digital content item that can entice purchasers to enter a transaction for a right to the content item.

A next step is that the selling service or content owner provides the audiovisual content items, e.g., promotional materials, to the seller. Such provision may be for free or for a fee, and may include any of the types of audiovisual content items noted above. The selling service may further provide web services, e.g., a premade website or a template, to the seller (step 62). The seller may also create their own site, e.g., with custom commentary, forums, user feedback pages, or the like. A seller may further receive certain promotional or marketing materials directly from the content owner.

In some instances, the seller may use a site provided and hosted by the content owner or selling service. In this case, the seller may embellish the provided site with their own clips, stills, mash ups, or the like, in order to personalize the site and create “brand identification” with the seller.

A next step is that the transaction is conducted between the purchaser and the content owner (step 64). This step may be provided in any of the ways described above in connection with FIG. 2(B). The purchaser then receives the agreed-upon right to the content item (step 66), and again such is provided as noted above.

The seller may then receive a credit or benefit due to the transaction from the content owner (step 72). Besides monetary benefits, the seller may receive other sorts of compensation, e.g., free clips, promotional items, discounts, or the like. The seller may also receive additional content items, discounts on other or future content items, and so on.

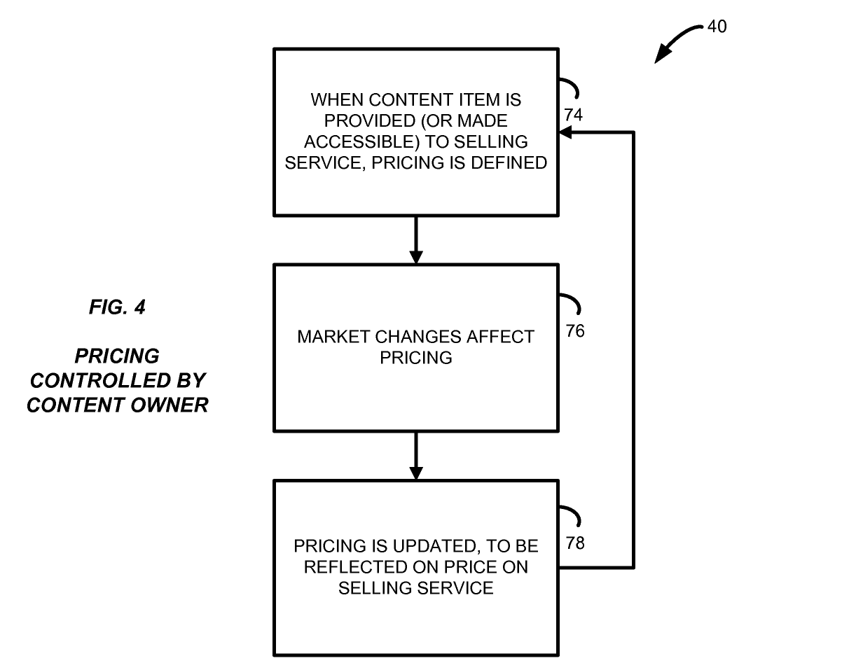

FIG. 4 is a flowchart 40 illustrating a fourth implementation of a method according to the principles described here, in particular illustrating a pricing model where the pricing is controlled by the content owner. In the flowchart 40, a first step is that, when a content item is provided or made accessible to a selling service, the pricing is defined by the content item rights owner (step 74). Market changes may then affect the pricing (step 76), which may then result in an updated price, to be reflected in the price on the selling service (step 78). In any case, once the selling service has received a price from the content item rights owner, the price can be reflected on various seller sites, subject to seller variations in pricing as described below.

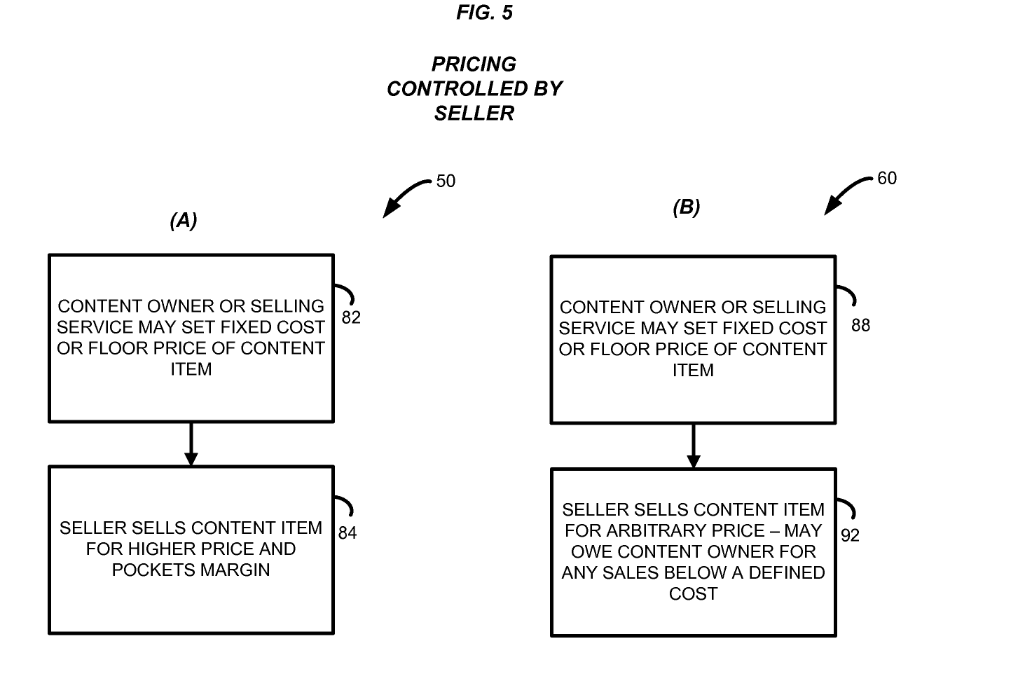

For example, FIG. 5(A) is a flowchart 50 illustrating a fifth implementation of a method according to the principles described here, in which pricing is controlled by the seller. In the figure, the content owner/the selling service may set a fixed cost or a floor price for the content item (step 82). In the former alternative, the seller is required to sell the content item at the fixed cost. In the latter alternative, the seller sells the content item for a higher price, and may then pocket the margin (step 84). In the alternative implementation of FIG. 5(B), a flowchart 60 indicates that a content owner or selling service may set a fixed cost or a floor price for the content item (step 88), but then the seller may sell the content item for an arbitrary price (step 92). In this alternative implementation, the seller may owe the content owner for any sales below a defined cost, and the amount owed may be directly paid to the content owner, may be deducted from future credits, or may be compensated for in another fashion. In this implementation, the seller is given more freedom to try alternative pricing models, bundling, product tie-ins, or the like.

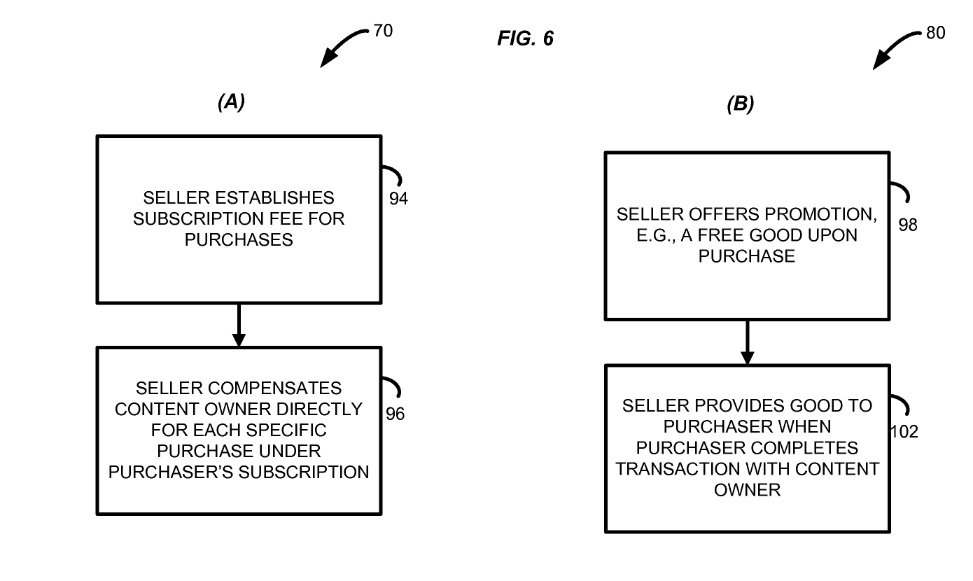

Variations of the selling system are now described. In FIG. 6(A), a flowchart 70 indicates that, instead of a set purchase price for each content item, a seller may establish a subscription fee for purchases (step 94). For example, a seller may offer to a purchaser a right to stream three movies a month for a set monthly fee. The seller may then compensate content owners directly for each specific purchase under the purchaser subscription (step 96). In this implementation, the seller is providing a bundle of rights for a set fee, but the seller may also arrange that the fee changes depending on the rights requested. For example, three first-run movies may cost more than three older ones.

In the alternative of FIG. 6(B), a flowchart 80 is illustrated in which a seller may offer a promotion, e.g., a free good upon the purchase of a content item (step 98). The seller then provides the good to the purchaser when the purchaser completes the transaction with the content owner (step 102). For example, the seller becomes notified of the completed transaction at the time when the seller receives a credit or benefit based on the transaction, if not sooner, and may provide the good at that time.

Other variations will also be understood. For example, instead of buying a right to a content item for themselves, a purchaser may purchase a right to be transferred to another. In other words, a purchaser may purchase a gift for a recipient from the content item rights owner. In the same way, a purchaser may purchase a discount coupon for a recipient. Where the gift is for a discount, the cost of the discount can be paid by any of the parties involved, e.g., the content item rights owner, the selling service, or the seller. Additional details of gifting implementations are described below in connection with FIGS. 8-12.

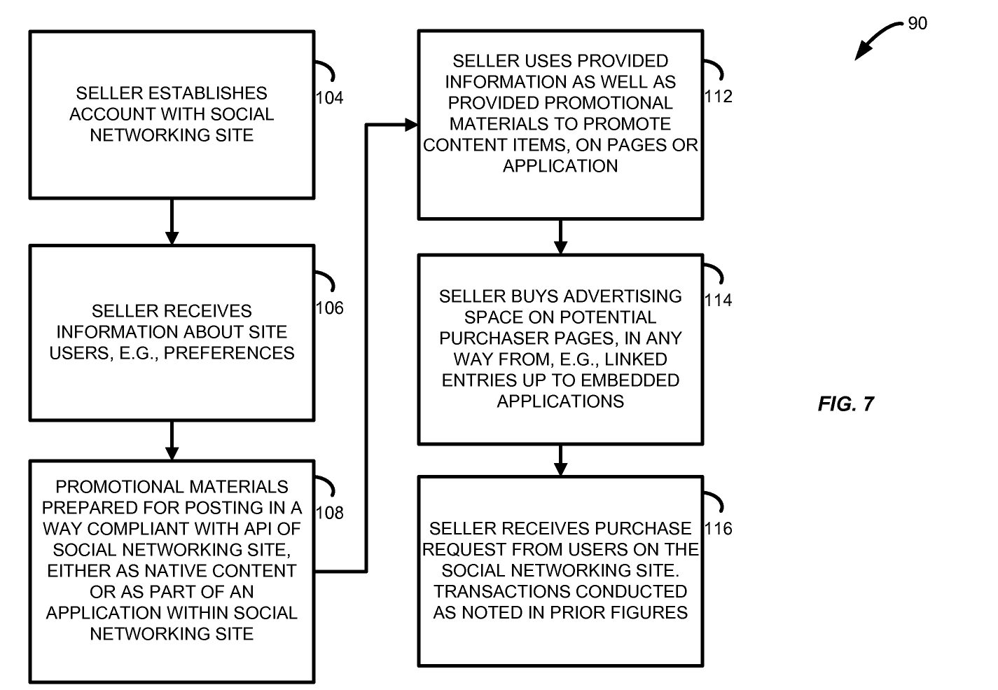

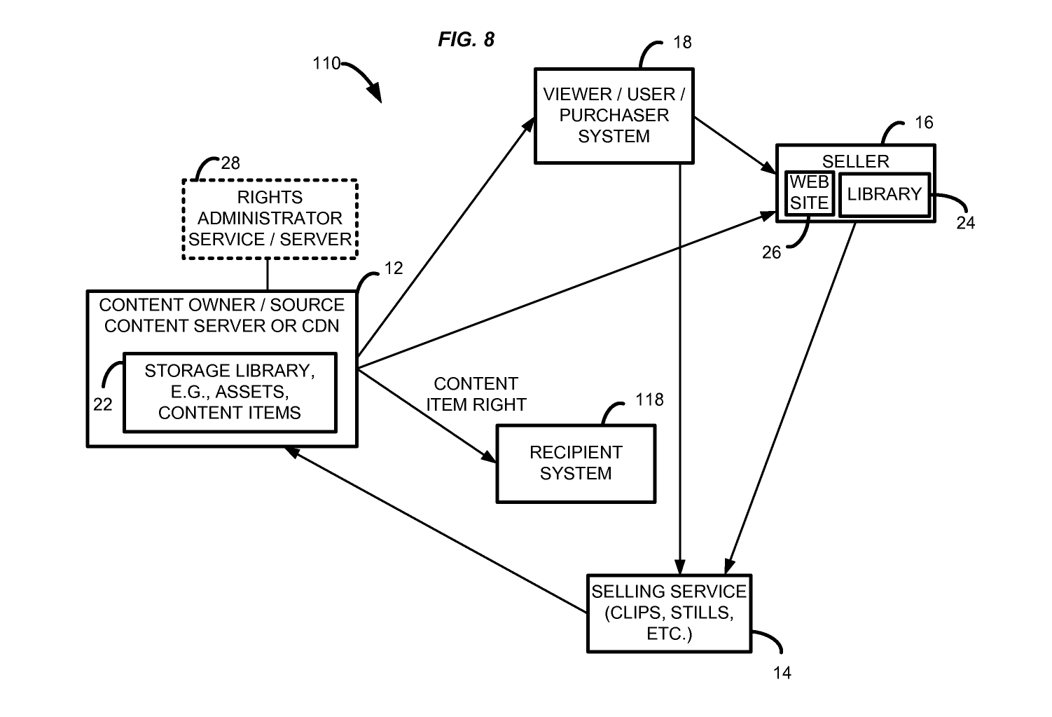

FIG. 7 shows a flowchart 90 illustrating a ninth implementation of a method according to the principles described here. In this implementation, a seller leverages functionality on a social networking site to further promote the content items in their library.

Certain of the steps are similar to those disclosed above. In a first step, the seller establishes an account with the social networking site (step 104). In an optional step, the seller may receive information about site users, e.g., usernames and various respective preferences they have indicated (step 106). Such information may be gleaned by research or by purchasing such information from the owner of the social networking site. In one variation, a seller may request and purchase information about social networking site members who have indicated an interest in the type of content the seller has for sale.

Promotional materials, which may have been received as audiovisual content items as noted above, may then be prepared for posting in a way compliant with an API of the social networking site (step 108). Such posting may occur either as native social networking site content, or as part of an application running within the social networking site. Additional details on the interaction of such materials with social networking sites are provided in co-pending U.S. patent application Ser. No. ______, entitled “SYSTEM AND METHOD FOR SOCIAL INTERACTION ABOUT CONTENT ITEMS SUCH AS MOVIES”, filed on even date herewith, owned by the assignee of the present application and hereby incorporated by reference in its entirety.

Once the seller has received information about potential purchasers and has prepared the audiovisual content items for posting, the seller may then promote the content items in their library, e.g., on user pages or on a separate application on the site (step 112). In so doing, the seller may further buy advertising space on potential purchaser pages. In a simple case, the seller may include an illustration of the content item and a link to the content owner's website. In a more complicated case, the seller may develop an application for running on the social networking site, the application marketing the content item or items available in a highly interesting and significant way. For example, the application may display a clip of available content items, with promotional materials superposed on the clip.

A seller may then receive a purchase request from users on the social networking site, and subsequent transactions may be conducted as noted in the prior figures (step 116). Generally, a primary difference will be that instead of the request coming from the purchaser system, e.g., an address associated with the purchaser system on the Internet, the request will come from the social networking site, or the purchaser's presence thereon.

Variations of the system will be noted. For example, the selling service, online content service, or rights administrator service, may incorporate their own social networking sites, and user interactions may be via the social networking site hosted and operated by the respective entity.

FIG. 8 is a schematic diagram of a second implementation of a system according to the principles described here, in particular illustrating a gifting system 110. Most of the components of a gifting system 110 illustrated are the same as those in FIG. 1, and their descriptions are not duplicated. However, a recipient system 118 is illustrated as receiving a right to a content item from the content owner 12, which generally transfers following the time the transaction is completed between the purchaser and the content owner.

The gifting system 110 may be situated as a application component external of a direct-to-consumer (“D2C”) application, such as may be operated by an online content service or other content owner, a retailer site, or rights administrator service, or may form a component of any of these. In general the gifting system 110 is required to have access to a D2C application for purchase and transfer of rights to content items, and may further access a rights administrator service to either obtain rights or to arrange for rights to be added to a user account, e.g., the recipient's. Sites such as retailer sites or social networking sites may act as intermediaries and even significant functionaries in a purchase transaction, but the same will generally interact with the D2C application to complete a transaction.

Variations of this system will be seen. For example, if a rights administrator service is employed to access numerous online content services, the rights administrator service may function as an intermediary between the content owner and the recipient system. That is, the rights administrator service may provide the right to the content item to the recipient upon the completed transaction between the purchaser and the rights administrator service or between the purchaser and the content owner directly.

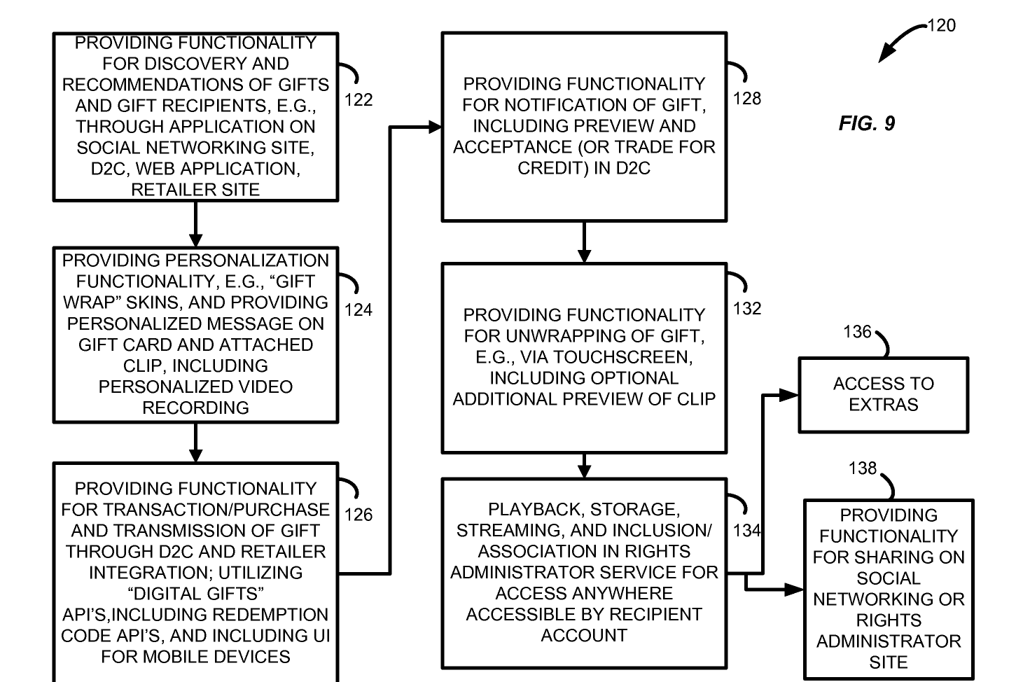

FIG. 9 is a flowchart 120 illustrating a tenth implementation of a method according to the principles described here. In this implementation, a gifting system provides significant additional functionality in the case where a digital content item such as a movie is gifted to a recipient. A first step in the flowchart 120 is that the system provides appropriate functionality for discovery and recommendations of gifts and gift recipients, e.g., through an application on a social networking site, a D2C site, a web application, or a retailer site (step 122). For example, the system may provide a movie catalog from an online content service, where the online content service provides D2C sales, and a potential purchaser may browse potential gifts by browsing the catalog. The application employed for browsing may be within the social networking site, within an online content service, a separate web application, or within a retailer site such as that which may be hosted and operated by a “big box” store. Where the system is aware of certain preferences of the purchaser or potential recipients, which may generally be the case when the system is implemented by a social networking site, or by another site for which user preferences are defined, then recommendations may be provided to the potential purchaser of suitable gift items, recipients for whom an event may be imminent, e.g., a birthday, or the like.

A next step is that system provides functionality for personalization (step 124). The personalization may take a number of forms. For example, the content item may be modified so as to have a gift wrap image appear. In one specific example, if a movie is purchased for a recipient, a DVD album of the movie may be presented to the recipient, with appropriate artwork, and a gift wrap may appear superposed on top of the imaged album. The content item with gift wrap is termed herein a “packaged” content item. By leveraging functionality such as a touchscreen, the act of “swiping” on the giftwrap may cause the appearance of the removal of the giftwrap. Suitable other functionality will be understood by one of ordinary skill in the art given this teaching. It will also be understood that personalization functionality may be minimal, e.g., may simply be a notation of the purchaser's name or a short note from the same.

Other personalization items may include a personalized message on a gift card, a clip pertaining to the content item, which may include specific footage from the content item. The footage may be official trailers or special scenes from the content item or particular clips chosen by the purchaser based on known interests of the recipient. A personalized video recording from the purchaser or the like may also be provided along with the content item.

A next step is that the system provides functionality for a transaction, e.g., a purchase of the content item, as well as transmission and delivery of the gifted content item (step 126). Such may generally occur through the integration of the gifting system with the D2C site. Moreover, if the gifting system forms part of a rights administrator service, then integration will also occur between the rights administrator service and the online content or D2C application. If the gifting system forms a part of an online retailer website, then integration will occur between the online retailer website and the online content or D2C application.

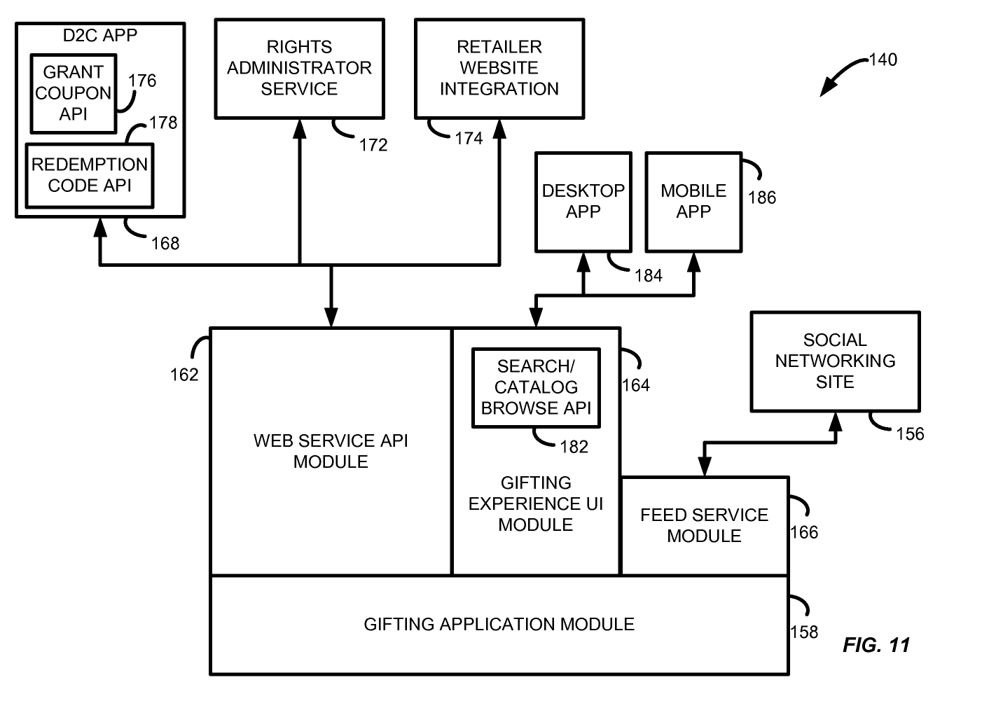

In many cases, various “digital gifts” APIs may be developed, including redemption code APIs that enable redemption codes to be entered by a recipient, e.g., who has received a redemption code as an embedded code in a delivered message or file, and which when redeemed are converted to rights or access to a particular content item when submitted to an online content service or other D2C site. Such may be fully implementable on mobile devices as well, for both uploading and downloading. Additional details of coupon and redemption code APIs are described below with respect to FIG. 11.

A next step is that the system provides functionality for a notification of the gifted content item, including a preview of the item, as well as for acceptance or trade for credit if the recipient does not accept the item (step 128). Such notifications may be by text message, a social networking site message, a message through the D2C application, an e-mail, a message through the rights administrator service, or the like. In such ways, the system notifies the recipient that they have received a gift. When the recipient logs on to receive the gift, they may receive a preview of the content item. If they decide to accept the content item gift, they receive the rights paid for by the purchaser. If they elect to not receive the content item, functionality may be provided to allow the recipient to receive a credit on a respective recipient account, or alternatively an exchange may be provided.

A next step is that functionality is provided for the “unwrapping” of the gift (step 132). As noted above, a tactile “unwrapping” of the gift may be afforded by utilizing a touchscreen to provide the appearance of removing a gift wrap in touched areas. The unwrapping may automatically lead to a preview; as in a “physical” unwrapping, a recipient would be led to additional information about content item.

Once the recipient has received the gift, playback, storage, streaming, as well as inclusion or association in a rights administrator service, may be provided to the recipient as delineated in the rights the purchaser paid for (step 134). Where the right is one administered by a rights administrator service for access from a cloud-based storage, the recipient may access the purchase content item from virtually anywhere for which Internet access is available.

Following initial access, or even prior to, a recipient may be given access to extras (step 136), such as of the type which may be provided on a DVD, e.g., director's commentary, cut scenes, bloopers, subtitles, additional languages, or the like. Functionality may further be provided for sharing certain details of the content item or transaction on a social networking site or on a social networking module operated by another site, such as a rights administrator site or an online content service (step 138).

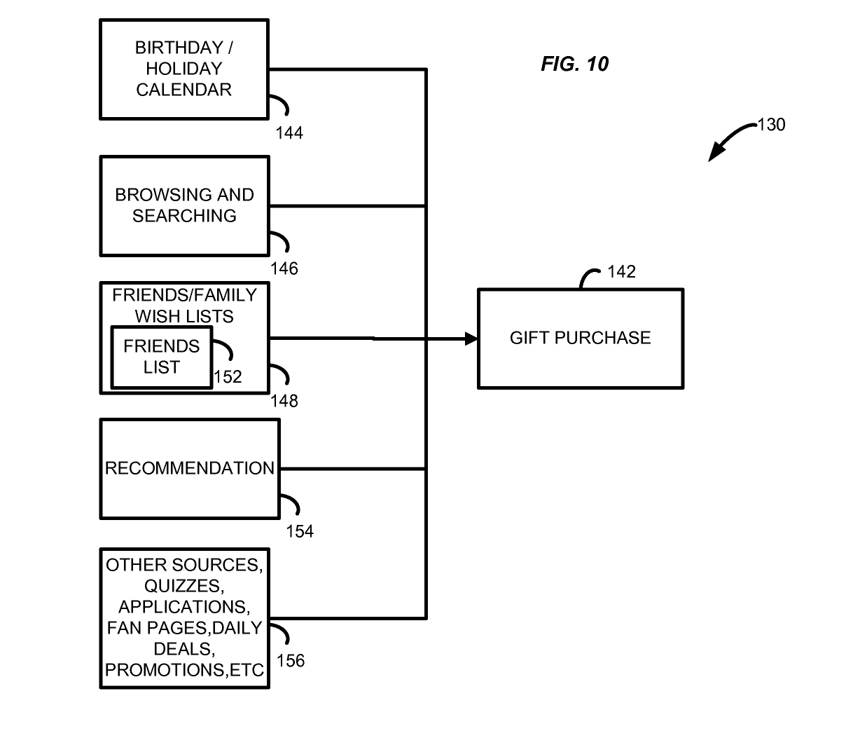

FIG. 10 provides a schematic diagram 130 illustrating ways and sources in which a gift purchase 142 may be initiated. These ways and sources may be in the context of a number of different types of sites and applications, including a social networking site, a rights administrator service, an online content service, or the like.

As one source, if the social networking site or the like includes information about users' important events, e.g., birthdays, anniversaries, and so on, the site may remind affiliated users, e.g., those on a friends list, about the upcoming event, and may prompt the same to purchase an appropriate gift (step 144). A gift may be context-appropriate, such as a movie about a wedding to celebrate a wedding anniversary.

As another source, the browsing and searching functionality described above may be leveraged to provide a resource for purchasers to assist in making purchasing decisions (step 146). The browsing and searching functionality may provide not only information about potential gifts but also about potential recipients. A wish list associated with a friend or family member may also be employed to determine potential purchases (step 148). In a corollary implementation, a group of friends 152, e.g., those on a friends list, may be invited to purchase a recommended movie gift for a friend celebrating a special event.

As another source, a direct recommendation may be made from a friend, an influential source of whom the user is a fan or follower, an organization the user likes, or any other such actor (step 154). As yet other sources, a variety of types of applications may be employed, including quizzes which test knowledge about a content item, applications about a content item, including game applications, fan pages for content item, special promotions such as “daily deals”, and the like (step 156). In one particular type of daily deal, the more people who purchased the content item, the better the discount may be. In one particular type of game application, the answers to various questions may reveal more and more about a particular content item; the first player to guess the content item correctly receives a free copy.

Numerous other variations will be apparent to one of ordinary skill in the art given these teachings. For example, a program may be initiated whereby a user can attempt to convince a social networking community that the user is the biggest fan of a movie, and the community may then be asked to donate to their cause, either by purchasing the movie, product tie-ins, badges, digital widgets, or the like.

FIG. 11 illustrates a schematic diagram 140 of a third implementation of a system according to the principles described here. In the diagram 140, basic gifting functionality is provided by a gifting application module 158. The gifting application module 158 is coupled to various other modules to provide the functionality described above. For example, the gifting application module 158 is coupled to a web service API module, which provides an API to connect to other services which are or may be used, including a D2C application 168, a rights administrator service 172 such as the UltraViolet™ system described above, or retailer websites 174. In one specific implementation, a D2C application 168 exposes a grant coupon API 176 and a redemption code API 178 which may be employed to create a coupon code for a content item or group of content items, as well as a redemption code for that coupon. The grant coupon API 176 may limit the access to a specific title or to any title as business rules dictate. The grant coupon API 176 and redemption code API 178 may further process the conversion of the redemption code for the recipient. Where a rights administrator service 172 is employed in the sale of assets to be added to a recipient's UltraViolet™ “rights locker”, the purchase transaction itself may still be provided by and take place within the D2C application.

The gifting application module 158 is further coupled to a gifting experience UI module 164. The gifting experience UI module 164 may be embodied in a number of ways, including in a desktop application 184, which may in turn take the form of a web or social networking service application to provide an experience to create the custom wrapping for the gift. On the recipient side, the same enables the gift unwrapping experience, as well as providing for the entry of redemption codes or the like. For such desktop applications, a less tactile unwrapping experience may be provided for recipients that do not have touchscreens. For example, a mouse over may be employed to unwrap gifted content items. The gifting experience UI module 164 may further be embodied in a mobile application 186, which by virtue of the touchscreen of most mobile devices may allow the tactile unwrapping experience as described above. The touchscreen or other data entry component may also facilitate the conversion of the redemption code.

The gifting application module 158 may further be coupled to a feed service module 166. In this manner, in order to socialize the digital gifting experience, the social networking feed service module 166 may be employed that allows publication of the transaction in a way compliant with an API of the respective social networking site. In so doing, the feed service module 166 prepares the data to be posted, including various promotional or other materials, in a way that may be displayed on the social networking site, including providing for the allowance of “likes”, commenting, and so on.

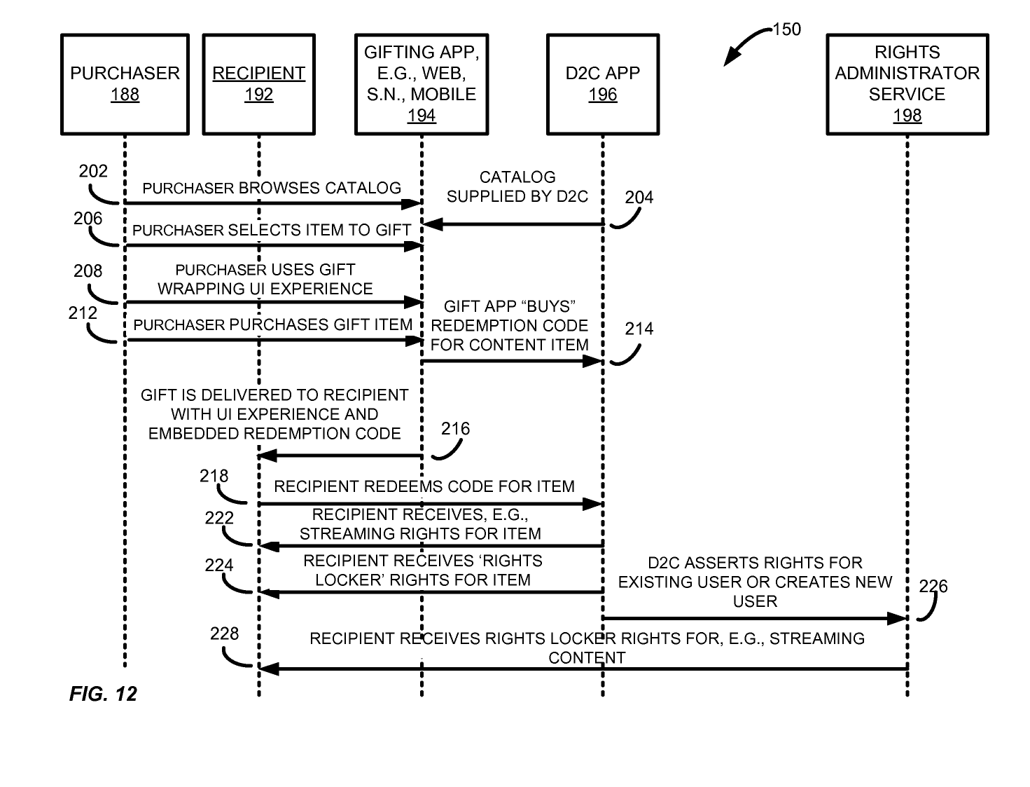

FIG. 12 illustrates an exemplary sequence diagram 150 of an implementation according to the principles described here. In the figure, a purchaser 188 is illustrated along with that intended recipient 192. A generic application 194 is illustrated, and the same may embody a web application, a social networking site application, a mobile application, a retailer application, or any such third-party application or site in which a transaction may be initiated. A D2C application 196 is illustrated, the same embodying the content item rights owner. A rights administrator service 198 is illustrated, the same arranging for content item distribution from a variety of online content services or D2C applications. In the figure, a right to the content item is given by the D2C application, and the same is added to a recipient's user account with a rights administrator service. Variations of such arrangements will also be understood to be possible.

In a first step 202, a purchaser browses a catalog, the catalog supplied by the D2C application to the application 194 in a step 204. It will be understood that other methods may be employed to bring content items to the attention of a purchaser, including the ways and sources illustrated in FIG. 10. The purchaser then selects a content item to gift to a recipient in step 206, and the selection is communicated to the application 194. The purchaser may employ the gift wrapping and other personalization UI functionality in step 208, these choices communicated to the application 194. The purchaser then purchases the gift item in step 212, in a transaction conducted between the purchaser 188 and the application 194. The gift application then purchases a redemption code for the content item in step 214 from the D2C application 196. The gift is delivered to the recipient in step 216 from the application 194. The gift includes an embedded redemption code, and is provided with the UI experience selected by the purchaser, including unwrapping, introductory personalized video, preview clip, or the like.

The recipient then redeems the redemption code for the item in step 218, from the D2C application 196, and receives rights for the item from the same in step 222. The recipient may receive other rights for the item in step 224, including a right to include the item in a rights locker such as may be administered by the rights administrator service 198, in which case the D2C application 196 asserts rights for the recipient in step 226. If the recipient is an existing user of the rights locker, the rights are added to the user account. Alternatively, a new user account may be created. Subsequently, the recipient receives rights for the content item from the rights administrator service 198 in step 228, e.g., a right to stream the content item to any system affiliated with the recipient.

One implementation includes one or more programmable processors and corresponding computer system components to store and execute computer instructions, such as to provide the movie seller service, the seller site or page, the commercial transaction service, e.g., at the content owner site, and the fulfillment service, e.g., at the content owner site. Another implementation includes processors and components to store and execute computer instructions, such as to provide the gifting functionality which interacts with a D2C application, a rights administrator service, retailer websites, social networking sites, and the like. Such programmable processors and corresponding computer system components generally include non-transitory memory or memories bearing computer readable instructions capable of performing any of the steps described above.

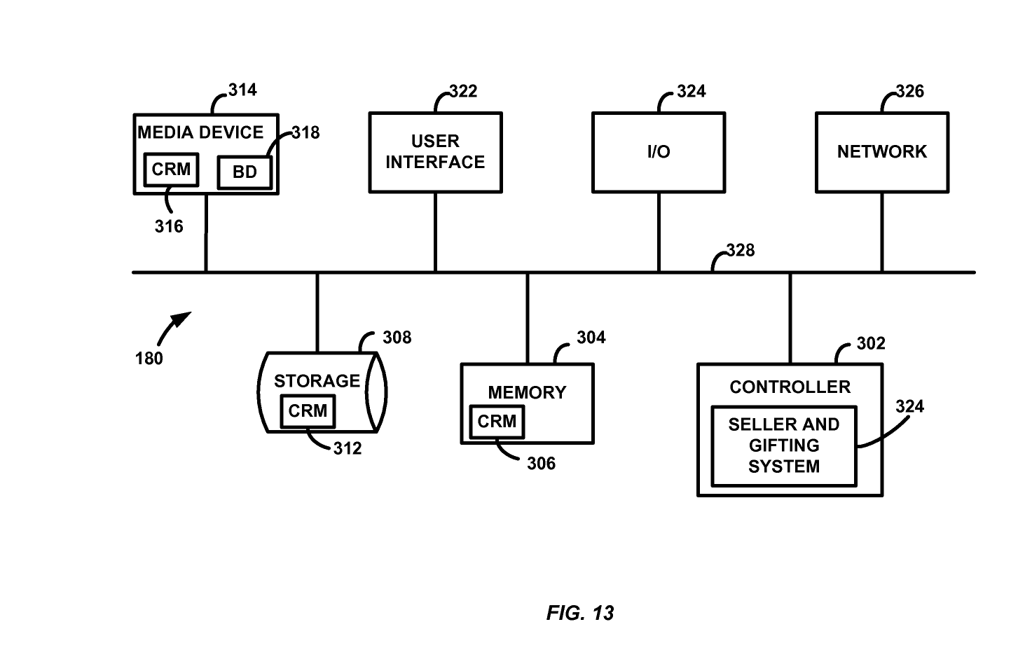

For example, FIG. 13 illustrates a third exemplary structure of a computing system 180 that may be employed to implement one or more of the features described herein. Such a computing system 180 may generally include a PC, tablet or laptop computer, mobile device or the like (e.g., devices associated with elements 12, 14, 16, 18, 28, or 118). Such a device includes a memory 304, which may include a non-transitory computer readable medium 306 as well as memories bearing computer readable instructions capable of performing any of the steps described above, a storage area 308, which may include a non-transitory computer readable medium 312 as well as storage areas 22 and 24 described above, a means 314 for receiving a computer-readable medium 316, shown in alternative exemplary form as a Blu-ray® disc player/recorder 318, a user interface 322, an input/output (I/O) interface 324, and a network interface 326 for connection to online resources. These components are interconnected by a common bus 328. Alternatively, different connection configurations can be used, such as a star pattern with the controller at the center.

A controller 302 controls the operation of the device 180 and its components. The controller 302 loads instructions from the memory 304 or an embedded controller memory (not shown) and executes these instructions to control the system. In its execution, the controller 302 may provide the system for providing a selling and gifting functionality for movies and other content items as, in part, a software system. Alternatively, this service can be implemented as separate components in the device 180.

The memory 304 stores data temporarily for use by the other components of the device 180, such as for storing applications during execution. In one implementation, memory 304 is implemented as RAM. In some implementations, memory 304 also includes long-term or permanent memory, such as flash memory and/or ROM.

The storage area 308 stores data temporarily or long term for use by other components of the device 180, such as for storing data used by the system for the selling or gifting application. In one implementation, storage 308 is a hard disk drive. In another, storage 308 is a solid state drive or comprises flash memory or the like.

The media device 314 receives removable media and reads and/or writes data to the inserted media. In one implementation, the media device 314 is an optical disc drive or disk burner such as a Blu-ray® drive.

A user interface 322 includes components for accepting user input from the user of the device 180 and for presenting information to the user. In one implementation, the user interface 322 includes a keyboard, a mouse, a touchscreen, audio speakers, and a display.

The I/O interface 324 includes one or more I/O ports to connect to corresponding I/O devices, such as external storage or supplemental devices, e.g., a printer, MP3 player, or a PDA. In one implementation, the ports of the I/O interface 324 include ports such as: USB ports, PCMCIA ports, Firewire® ports, serial ports, and/or parallel ports. In another implementation, the I/O interface 324 includes an interface for wireless communication with external devices.

The network interface 326 includes a wired and/or wireless network connection, such as an RJ-45, a WiFi interface (802.11), or an Ethernet connection. Numerous other types of network connections will be understood to be possible, including WiMax, 3G or 4G, satellite, Bluetooth®, or the like. Any of these may be employed to connect to online resources.

The device 180 and includes additional hardware and software typical of computing devices, e.g., power, cooling, operating system, though these components are not specifically shown in the figure for simplicity. In other implementations, different configurations of the device can be used, e.g., different bus or storage configurations or a multi-processor configuration.

It is to be understood that the arrangement may be implemented in any number of computing devices, including laptop computers, desktop computers, tablet computers, handheld computers, mobile phones, smart phones, and the like.

Systems and methods have been described to provide selling and gifting functionality for content items, e.g., movies, television shows, and the like. The examples described above are intended to be illustrative and not limiting, and variations of the system are possible as well. For example, various types of content can be shared, such as television or Internet video, audio, games, books, or physical objects, e.g., clothing or devices. Additional variations and implementations are also possible. For example, while the system and method have been described with respect to significant rights being obtained and utilized on the part of sellers, it will be understood that content owners will generally have primary input on how their content items are marketed and promoted, and thus will usually be able to revoke selling rights at any time. In addition, while the system and method have been described with respect to recipients simply receiving various types of access to content items, the recipients may then manipulate the content items in various ways, including use of functionality described in co-pending U.S. patent application Ser. No. 13/227,795, entitled “SYSTEM AND METHOD FOR PROVIDING VIDEO CLIPS, AND THE CREATION THEREOF”, owned by the assignee of the present application and incorporated by reference herein in its entirety. Clips resulting from recipient edits may then be posted to social networking sites.

Accordingly, the technology is not limited to the specific examples, e.g., of selling movies, discussed above, which are provided only as example forms of implementing the claims.

1. A method of providing a gifting functionality for an online marketplace for digital content items, comprising:
a. providing a browsing and discovering functionality for a plurality of content items;
b. providing a selection functionality, wherein a user may select a content item from one or more of the plurality for gifting;
c. providing a personalization functionality for the selected content item, wherein the content item may be combined with one or more personalization content items into a packaged content item;
d. providing a transaction functionality for the packaged content item, wherein a gifter provides compensation at least for the selected content item to a content item rights owner;
e. providing a transmission functionality for the packaged content item, wherein the packaged content item is caused to be transmitted and delivered to a recipient; and
f. providing a preview functionality for the packaged content item, wherein the packaged content item may be previewed prior to acceptance by the recipient.

2. The method of claim 1, wherein a personalization content item includes a gift wrapping skin for the selected content item, and further comprising providing an unwrapping functionality for the packaged content item, wherein a user interface of a recipient device is configured to provide the appearance of unwrapping the gift wrapping skin of the packaged content item.

3. The method of claim 2, wherein the appearance of unwrapping the gift wrapping skin includes removing the appearance of the gift wrapping skin from locations activated by a user on a touchscreen.

4. The method of claim 1, further comprising associating the selected content item with a recipient account.

5. The method of claim 4, wherein the associating includes downloading the content item to a device affiliated with the recipient account, streaming the content item to a device affiliated with the recipient account, providing a rental right of the content item to the recipient account, or associating the content item with the recipient account in a digital rights locker.

6. The method of claim 1, further comprising receiving a request to share information about the selected content item from the recipient account, preparing the information in a way compliant with an API of the social networking site, and transmitting the information to the social networking site.

7. The method of claim 1, further comprising receiving a request to return the selected content item from the recipient account, or a request to exchange the selected content item, and providing a functionality to perform the return or exchange.

8. The method of claim 4, wherein the associating includes receiving an entry of a redemption code.

9. The method of claim 1, further comprising providing a gifting reminder functionality, the gifting reminder functionality serving to remind users, associated with a potential recipient, of an event associated with the potential recipient.

10. A non-transitory computer readable medium, comprising instructions for causing a computing device to perform the method of claim 1.

11. A system for providing a gifting functionality for an online marketplace for digital content items, comprising:
a. a web service API module, the web service API module configured to interact with a source of rights to digital content items; and
b. a gifting experience user interface module, the gifting experience user interface module configured to interact with a user device to receive gift purchase requests from purchasers and provide gifted digital content items to recipients.

12. The system of claim 11, wherein the web service API module includes a grant coupon API module for providing and implementing business rules for a content item and a redemption code API module for receiving a redemption code from a recipient and converting the redemption code into a right to a content item to be delivered to the recipient.

13. The system of claim 11, further comprising a feed service module for populating a feed about a transacted content item usable by a social networking site to publish information about the transaction to the social networking site.
